(19) United States
(12) Patent Application Publication
(10) Pub. No.: US 2003/0016616 A1
(43) Pub. Date: Jan. 23, 2003

(54) Disk drive

(75) Inventors: Hajime Nishimura, Hitachinaka (JP); Yoshihiro Fukagawa, Yokohama (JP); Seiji Inaba, Hitachinaka (JP)

Correspondence Address: McDermott, Will & Emery, 600 13th Street, N.W., Washington, DC, 20005-3096, US

(73) Assignee: Hitachi-LG Data Storage, Inc.

(21) Appl. No.: 10/142,059

(22) Filed: May 10, 2002

(30) Foreign Application Priority Data
Jul. 17, 2001 (JP) 2001-216236

(51) Int. Cl. G11B 17/30; G11B 21/02

(52) U.S. Cl. 369/223

(57) ABSTRACT

A stepping motor (5) for rotating a screw (14) for driving a pickup (3) for axial movement is disposed near the inner circumference of a disk (100) with its axis aligned with that of the screw (14). The stepping motor (5) has a thickness of 7 mm or below.

### BACKGROUND OF THE INVENTION

The present invention relates to techniques for recording information on and reproducing recorded information from an optical disk.

A small, thin optical disk drive (so-called slim drive) capable of being incorporated into a notebook-size personal computer, similarly to general optical disk drives, includes a thin optical pickup for recording information on and reproducing recorded information from an optical disk, a disk-driving motor for driving the optical disk for rotation, and a feed mechanism including a feed motor, for driving the optical pickup for movement along a radius of the optical disk. The feed mechanism of the disk drive, as mentioned in Japanese Patent Laid-open Nos. 11-149724 and 2001-101811, includes a dc motor, a screw, a gear-type reduction mechanism, and a rack combined with the optical pickup and engaged with the screw. The dc motor drives the screw for rotation through the reduction mechanism to move the optical pickup combined with the rack.

The feed mechanism is required to move the optical pickup quickly and to position the optical pickup accurately. The pitch of the screw thread of the screw, frictional torque of the feed mechanism and the like affect positioning accuracy. Whereas the reduction of the pitch of the screw thread of the screw improves positioning accuracy, the same increases time necessary for positioning the optical pickup. Dislocation of an objective included in a recording optical apparatus for recording information on an optical disk, for forming a light spot on an optical disk for recording or reproducing from the axis of a light beam formed in an optical pickup must be smaller than that of the objective of the conventional reproducing optical disk drive, and an optical pickup included in the recording optical apparatus must be positioned with an accuracy higher than that in which the optical pickup of the reproducing optical apparatus must be positioned. The optical pickup of the recording optical apparatus is larger than that of the reproducing optical apparatus. Since only a limited space is available for installing the feed mechanism and the motor due to various restrictive conditions, the output capacity of the motor is limited. To realize a recording optical disk drive provided with an optical pickup capable of being moved as fast as an optical pickup included in a conventional reproducing optical disk drive can be moved, taking the foregoing conditions into consideration, a first means is the reduction of the frictional torque of a feed mechanism, a second means is to employ a feed mechanism including gears engaged with no or small backlash, and a third means is the optimization of parameters including the pitch of the screw thread of a screw included in the feed mechanism and the torque constant of a motor employed.

From the foregoing point of view, a pickup feed mechanism including a dc motor and a reduction gear has the following problems.

A first problem, which relates to the positioning of the pickup, is that a mechanism for transmitting the power of the motor to the screw has many component parts which exert large frictional load on the motor. A second problems, which relates to the positioning of the pickup is, that a transmission mechanism includes gears and backlashes between the gears make the improvement of accuracy in positioning the pickup difficult. A third problem, which relates to quickly moving the pickup, is that gears generate large noise and the pickup cannot be quickly moved when the motor and the gears are positioned inaccurately. A fourth problem, which is a general problem, is that the pickup feed mechanism needs many component parts, resulting in being expensive and heavy, and a fifth problem is that the pickup feed mechanism needs a large space for installation.

An optical disk drive built in a desktop personal computer disclosed in, for example, Japanese Patent Laid-open No. 11-297007 is provided with a stepping motor disposed coaxially with a screw outside a disk and does not have any gear-type transmission mechanism to solve the foregoing problems. In most conventional desktop personal computers, an optical disk is loaded into an optical disk drive by placing the optical disk on a tray and drawing the tray into the optical disk drive, and a driving unit including an optical pickup and a disk driving motor is raised to a working position to perform reproducing or recording operations. The comparatively large stepping motor is disposed outside a cylindrical region corresponding to an axial projection of the optical disk to prevent the stepping motor from touching the tray. The stepping motor and the screw are supported on a bracket, the bracket is placed on a chassis with positioning pins attached to the chassis fitted in positioning holes formed in the bracket, and the brackets thus positioned is fastened to the chassis with screws. In the optical disk drive for a desktop personal computer, a guide bar for guiding the pickup for movement is fastened directly to the chassis. Therefore, the accuracy of the positional relation between the guide bar and the bracket can be insured by accurate press work.

### SUMMARY OF THE INVENTION

However, it is difficult to reduce the thickness of the foregoing known optical disk drive and to form the optical disk drive in a small thickness, because nothing is considered to incorporate the stepping motor into a thin optical disk drive.

Accordingly, it is an object of the present invention to provide a thin disk drive including a pickup feed mechanism provided with a stepping motor.

Another object of the present invention is to provide a thin, small, lightweight, highly accurate, highly reliable disk drive at a low cost.

According to the present invention, a stepping motor is connected directly to a screw and is disposed such that the stepping motor does not touch other members and is able to exercise necessary functions.

The stepping motor is disposed near the inner circumference of a disk that rotates or an opening is formed in a part of a chassis corresponding to the stepping motor.

The stepping motor disposed coaxially with the screw for moving the pickup is formed in a thickness of, for example, 7 mm or below so that the stepping motor may not touch other members.

The disk drive is not provided with any gear-type transmission mechanism or reduction mechanism.

A guide bar is extended accurately in parallel to the screw to limit a maximum frictional torque to a value below an allowable value.

The stepping motor coaxial with the screw for moving the pickup is supported on a bracket, the screw has an end part near one of three vibration-isolating legs for attaching the disk drive to a loading mechanism, positioning parts are formed in an end part of the screw and a part of the bracket on the side of the stepping motor, and the screw is fixed to the chassis of the disk drive at two or more positions including a position near the stepping motor.

According to the present invention, a disk drive comprises a pickup for optically recording information on or reproducing recorded information from a disk; a pickup drive motor for driving the pickup for movement; and a disk motor for driving the disk for rotation; wherein the pickup is moved by a moving means including a screw, the pickup drive motor is a stepping motor, and the pickup drive motor is disposed on the side of the inner circumference of the disk.

Preferably, the pickup drive motor has a thickness equal to the diameter of the screw.

### BRIEF DESCRIPTION OF THE DRAWINGS

FIG. 1 is a perspective view of mechanical unit included in a disk drive in a preferred embodiment according to the present invention;

FIG. 2 is an exploded perspective view of the disk drive shown in FIG. 1;

FIG. 3 is a top view of the disk drive shown in FIG. 1;

FIG. 4 is a side elevation of the mechanical unit shown in FIG. 1;

FIG. 5 is a perspective view of a part of the mechanical unit shown in FIG. 1;

FIG. 6 is a rear view of a part of the mechanical unit shown in FIG. 1; and

FIG. 7 is a perspective view of an assembly of a bracket and a stepping motor.

### DESCRIPTION OF THE PREFERRED EMBODIMENTS

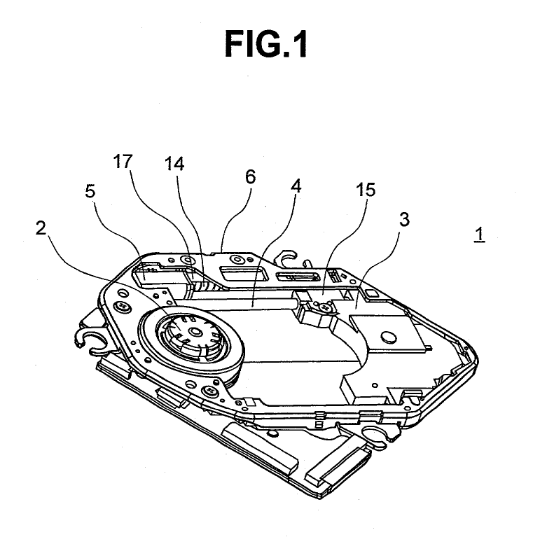

Referring to FIG. 1 showing a mechanical unit 1 included in a disk drive 7 in a preferred embodiment according to the present invention in a perspective view, the mechanical unit 1 includes a disk motor 2 for driving a disk, not shown, for rotation, a pickup 3 for recording information on and reproducing recorded information from the disk, a guide bar 4 for guiding the pickup 3 for movement along the radius of the disk, a stepping motor 5 for driving the pickup 3 for movement along the guide bar 4, and a chassis 6 for supporting the foregoing components.

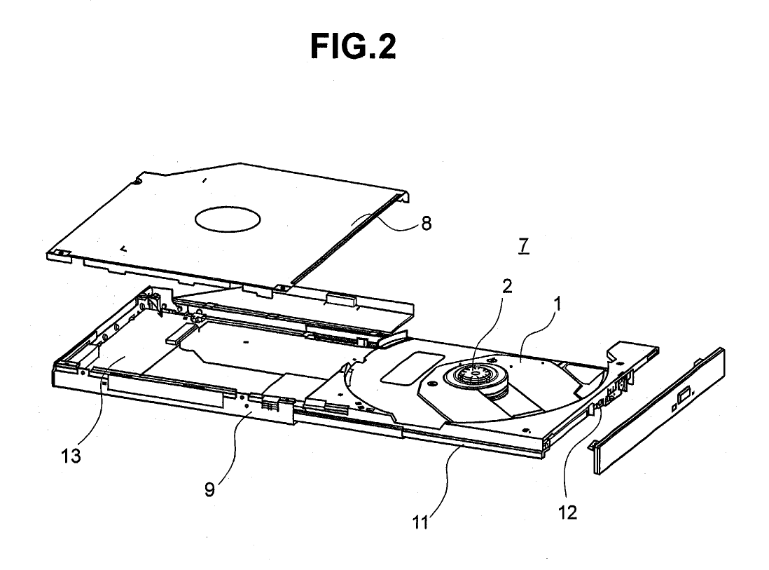

Referring to FIG. 2 showing the disk drive 7 in an exploded perspective view, the disk drive 7 has a case including a top half case 8 and a bottom half case 9. The disk drive 7 is about 12.7 mm in thickness, about 128 mm in width and about 127 mm in length. Placed in the case are a sliding tray 11 holding the mechanical unit 1 and capable of sliding out of the case to enable changing disks, an ejecting mechanism 12 combined with the sliding tray 11 to lock the sliding tray in and ejecting the sliding tray 11 outside the case, and a printed wiring board 13. In FIG. 2, the sliding tray 11 is drawn out of the case.

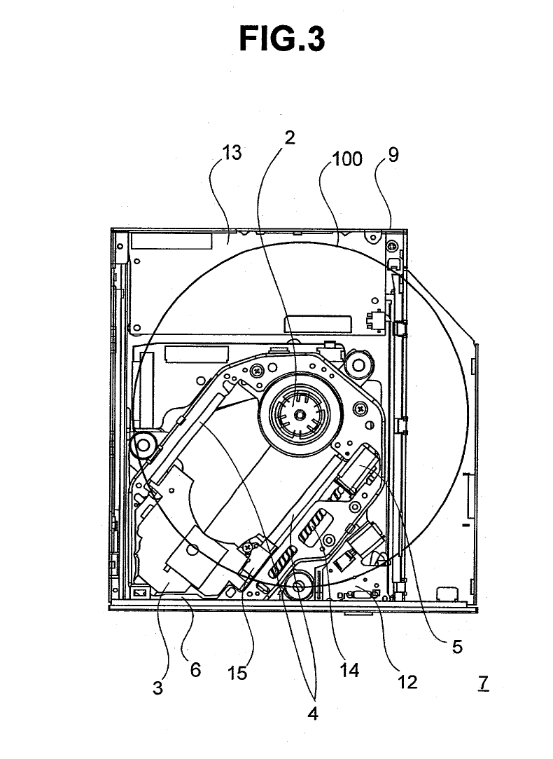

FIG. 3 is a top view of the disk drive 7. The pickup 3 of the disk drive 7 needs to record signals in or reproduce signals from a circumferential part of a disk 100. Therefore, the mechanical unit 1 is disposed such that the pickup 3 moves along a diagonal of the substantially rectangular case. The stepping motor 5 is disposed beside the disk motor 2, i.e., near the inner circumference of the disk 100, with its output shaft extended coaxially with a screw 14 extended in parallel to the guide bar 4. The stepping motor 5 will jut out from the case if the same is placed outside a region covered with the disk 100.

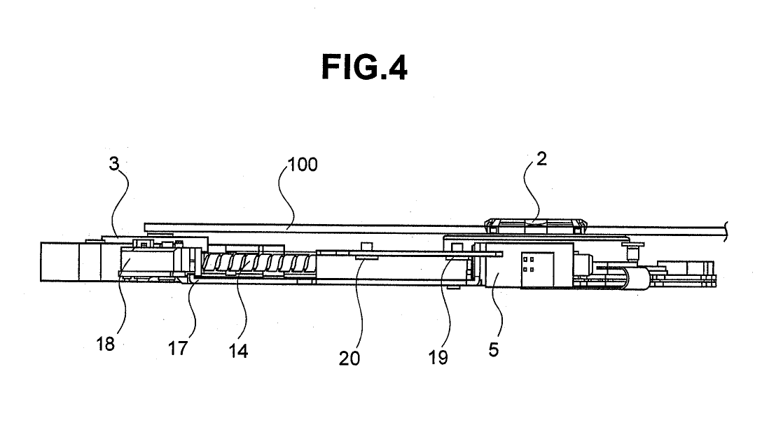

Referring to FIG. 4 showing the mechanical unit 1 of the disk drive 7 in a side elevation, the stepping motor 5 is one generally called an oval motor having a diameter of about 8 mm and a thickness of about 6.3 mm. The stepping motor 5 is disposed under the disk 100. The disk drive 7 is 12.7 mm in thickness and the lower surface of the disk 100 is at a height in the range of about 9 to about 10 mm from the inner surface of the bottom half case 9. Therefore, considering the precession of the disk 100, the thickness of a space available for installing the stepping motor 5 is about 7 mm or below. When the chassis 6 is superposed on the stepping motor 5, the distance between the upper surface of the chassis 6 and the lower surface of the stepping motor 5 is about 8 mm, which is greater than 7 mm. Therefore, an opening is formed in a part of the chassis 6 corresponding to the stepping motor 5.

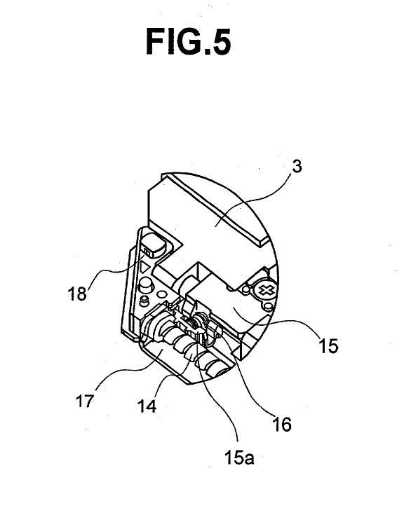

Referring to FIG. 5 showing a part of the mechanical unit 1 of the disk drive 7 in a perspective view, a rack holding member 15 combined with the pickup 3 holds a rack 15a engaged with the threaded part of the screw 14. The screw 14 is rotated to move the rack holding member 15 axially. Pressure is exerted on the rack 15a by a preloading spring 16 to prevent the disengagement of the rack 15a from the screw 14 when an impact is given to the rack holding member 15 or when the rack-holding member 15 is accelerated sharply. The pressure exerted on the rack 15a is high when the gap between the rack holding member 15 and the screw 14 is small and is low when the gap is large. A uniform gap must be formed between the rack holding member 15 and the screw 14 to exert a minimum necessary pressure on the rack 15a in order that a friction between the rack 15a and the screw 14 is not greater than an allowable value; that is, the guide bar 4, which determines the position of the pickup 3 with respect to a direction perpendicular to the moving direction of the pickup 3, especially the main shaft (guide bar near the screw) must be parallel to the screw 14.

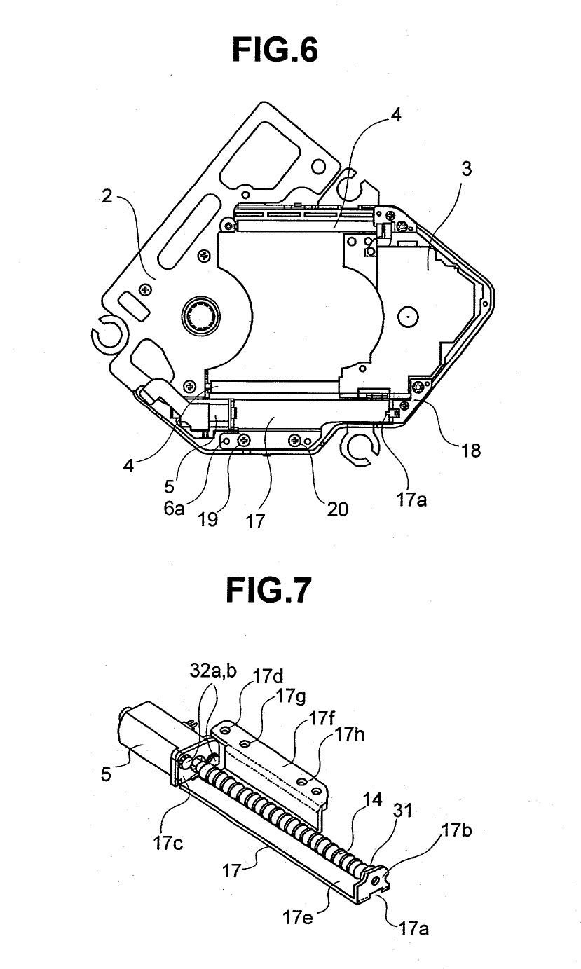

Referring to FIG. 6 showing the mechanical unit 1 of the disk drive 7 in a back view, a positioning groove 17a is formed in parallel to the screw 14 in a part of a bracket 17 opposite to the other part of the same to which the stepping motor is attached, i.e., a part on the side of the outer circumference of the disk 100. A guide piece 18 positions and supports the guide bar 4, and is engaged in the positioning groove 17a of the bracket 17 to position the bracket 17. The stepping motor 5 is fastened to the chassis 6 with screws 19 and 20. The stepping motor 5 is positioned by a reference projection 6a formed by punching and the guide piece 18. In this way, the outer circumference is positioned by one member with a span corresponding to the length of the screw 14. Thus the accurate parallelism of the guide bar 4 and the screw 14 in a plane parallel to the surface of the disk 100 can be insured. Although this positioning structure is not necessarily able to insure the parallelism of the guide bar 4 and the screw 14 with respect to a direction parallel to the thickness of the disk 100, friction between the rack 15a and the screw 14 is not increased significantly even if the guide bar 4 and the screw 14 are not perfectly parallel to each other with respect to the direction parallel to the thickness of the disk 100 because the rack 15a is formed of a resin and is capable of elastic deformation.

FIG. 7 shows the stepping motor 5 directly coupled with the screw 14 and attached to the bracket 17. The free end of the screw 14 is inserted in an opening formed in a resin bearing 31 fitted in an end part 17b of the bracket 17 to stabilize the rotation of the screw 14. The stepping motor 5 is fastened to a motor holding part 17c of the bracket 17 with two screws 32a and 32b. A jig is used for assembling the bracket 17, the stepping motor 5 and the screw 14 to insure that the screw 14 is spaced a predetermined distance apart from a positioning reference hole 17d and the runout of the extremity of the screw 14 is within a predetermined allowable range. A bar-shaped connecting part of the guide piece 18 engaged with the bracket 17 has a rectangular cross section and is inserted in the positioning groove 17a of the bracket 17. The connecting part of the guide piece 18 is held between the upper end of the positioning groove 17a and a base part 17e of the bracket 17 so that a predetermined clearance is formed between the connecting part and the base part 17e. The screw 14 is spaced vertically a predetermined distance apart from the guide bar 4. A predetermined clearance is secured between the connecting part of the guide piece 18 and the side surface of the positioning groove 17a such that the screw 14 is spaced horizontally a predetermined distance apart from the guide bar 4. The stepping motor 5 is positioned by using the jig such that an end part of the screw 14 on the side of the stepping motor 5 is at a predetermined position with respect to the positioning reference hole 17d and a mounting surface 17f of the bracket 17, and is fastened to the motor holding part 17c of the bracket 17 with the two screws 32a and 32b. The reference projection 6a and the positioning groove 17a are engaged with the connecting part of the guide piece 18, and the bracket 17 supporting the stepping motor 5 and the screw 14 is fastened to the chassis 6 by screwing the screws 19 and 20 in threaded holes 17g and 17h. When the connecting part of the guide piece 18 is engaged closely in the positioning groove 17a of the bracket 17 substantially with scarce clearance or the rack 15a is preloaded by a sufficient pressure, the bracket 17 may be fastened to the chassis 6 with only either the screw 19 or 20. The bracket 17 and fastening means for fastening the bracket 17 to the chassis 6 must be sufficiently strong and rigid because it is possible that a great force acts on the bracket when the disk drive 7 is dropped or shocked.

As apparent from the foregoing description, the disk drive of the present invention is thin, small, lightweight, inexpensive, highly accurate and highly reliable.

Although the invention has been described in its preferred embodiment, obviously many changes and variations are possible therein. It is therefore to be understood that the present invention may be practiced otherwise than as specifically described herein without departing from the scope and spirit thereof.

What is claimed is:

1. A disk drive comprising:
a pickup capable of optically recording information on or optically reproducing recorded information from a disk;
a pickup drive motor for driving the pickup for movement; and
a disk drive motor for driving the disk for rotation;
wherein the pickup is moved by a moving means including a screw, the pickup drive motor is a stepping motor, and the pickup drive motor is disposed at a position near the inner circumference of the disk.

2. The disk drive according to claim 1, wherein the pickup drive motor has a thickness approximately equal to a diameter of the screw.

3. A disk drive of about 12.7 mm in thickness comprising:
a pickup capable of optically recording information on or optically reproducing recorded information from a disk;
a pickup drive motor for driving the pickup for movement; and
a disk drive motor for driving the disk for rotation;
wherein the pickup drive motor is a stepping motor of about 7 mm or below in thickness, the pickup drive motor drives a screw for moving the pickup, extended coaxially with an output shaft included in the pickup drive motor for rotation, and the pickup drive motor is disposed at a position near the inner circumference of the disk.

4. The disk drive according to claim 3, wherein one end part of at least one of guide shafts defining a path for a specific point on the pickup, and one end part remote from the pickup drive motor of a bracket supporting the screw are positioned by a single positioning member.

5. The disk drive according to claim 3 or 4, wherein the bracket is disposed opposite to the disk with respect to the guide shaft, and a chassis supporting the disk drive motor.
